(19) United States
(12) Patent Application Publication
(10) Pub. No.: US 2020/0047362 A1
(43) Pub. Date: Feb. 13, 2020

(54) APPARATUS FOR MEASURING AND CUTTING DRYWALL

(71) Applicant: Arquimedes Hernandez, Monroe, NC (US)

(72) Inventor: Arquimedes Hernandez, Monroe, NC (US)

(21) Appl. No.: 16/102,686

(22) Filed: Aug. 13, 2018

(51) Int. Cl. B26B 29/06; B26B 5/00; B26D 3/08

(52) U.S. Cl. CPC B26B 29/06; B43L 7/14; B26D 3/085; B26B 5/005

(57) ABSTRACT

A drywall cutting tool is described. The drywall cutting tool has an elongated flat ruler with a knife blade and a handle attached to one end of the elongated flat ruler. A support bracket that has a flat top portion with a flange along one side and a pair of guides on the top. The guides receive the one end of the ruler allowing the ruler to slide along the top portion of the support bracket to any desired measurement length. A screw-down hand is also attached to the support bracket to pinch and secure the ruler at the guides so that the desired measurement length is maintained.

### FIELD OF THE INVENTION

This invention relates to cutting drywall generally and more particularly to such a drywall cutting tool which measures and aligns the guides with the cutting tool.

### BACKGROUND

It is known that when scoring or cutting (collectively herein cutting) wallboard materials such as gypsum board, wallboard, plasterboard, insulation board, or like materials particularly in construction applications that time to perform cutting operations can be reduced and quality of cut increased when using cutting tools referenced to an edge of the wallboard material as in the case of a T-Square guided knife.

Cutting of wallboard needs to be quite accurate in most cases as the material is often used in finishing interiors of buildings where fit ultimately affects the quality and appearance of the finish.

Furthermore, the cutting of wall board materials should be quick and easy to maximize installer productivity and reduce overall cost of installation. In most cases, wallboard materials can be cut by first scoring the surface, and then bending the board along the score line to break the board.

Scoring a long line of 4 feet, typical gypsum board width, or even longer lines of 8 to 12 feet or more can be difficult without a referenced guide. Long straight edges often get bent and malformed due to miss-handling during normal construction work and transportation between job sites.

Several attempts aimed at resolving this challenge have been made. One of the attempts was a board cutter including a T-Square and a common utility knife mounted to a slider which rides along the long leg of the T-Square and is fixed at a position by means of a clamp mechanism as in a thumb screw. The common utility knife is connected to the slider by way of a pivotal pin and clamped into a depth of cut position again using a thumb screw arrangement.

One of the primary drawbacks is that is difficult to cut the full face of a wallboard from edge to edge as the T-Square runs out before the knife has scored the whole length of the surface. This is particularly evident when cutting a wallboard while it is standing on end as when leaning against a wall, the leading end of the head of the T-Square is blocked by the floor or ceiling preventing the knife from reaching the edges closest to the obstructing floor or ceiling.

The problem of the guiding member or T-Square head of the scoring tool reaching the end of the wallboard sheet ahead of the cutting tool in either direction has long been problematic that others have attempted to resolve.

### BRIEF DESCRIPTION OF THE DRAWINGS

FIG. 1 is an exemplary support bracket for cutting drywall.

FIG. 2 is an exemplary ruler used to measure drywall.

FIG. 3 is a side view of the exemplary support bracket for cutting drywall.

FIG. 4 is an exemplary ruler handle for cutting drywall.

FIG. 5 is an exemplary view of the use of the drywall cutting tool positioned with a drywall board.

### DETAILED DESCRIPTION

Reference will now be made in detail to the present preferred embodiments, examples of which are illustrated in the accompanying drawings. All terms in the plural shall also be taken as singular and vice-versa. Further, any reference to be shall also be applicable to she and vice-versa. With reference to the drawings wherein like numerals represent like parts throughout the figures.

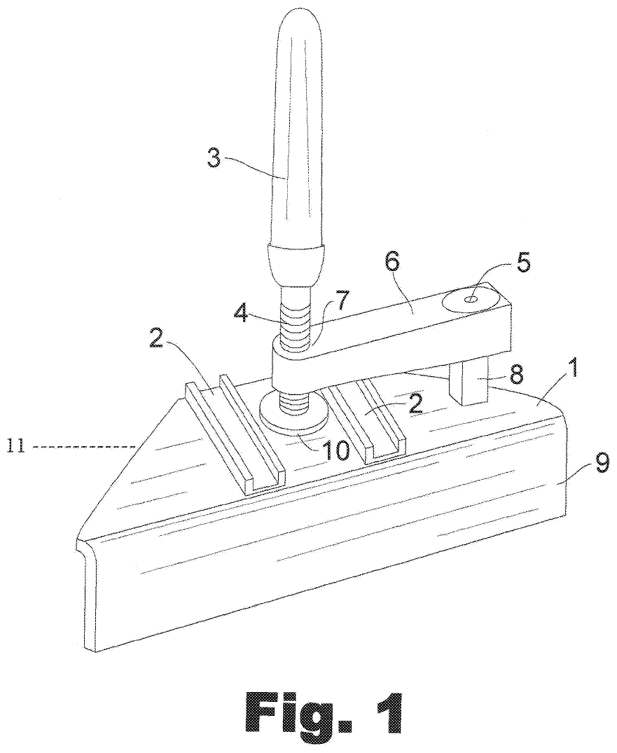

FIG. 1 presents an exemplary drywall cutting support bracket 1. The support bracket has a flanged plate 9. The flanged plate 9 may be rigid. The flanged plate 9 may be configured to be at different angles such as 45 degrees, 90 degrees, etc. The flanged plate 9 has a plurality of guide tracks 2 on an upper surface 11. In the exemplary embodiment, the guide tracks 2 are parallel.

Further, the flanged plate 9 also has a screw-down clamp handle 3 located between the guide tracks 2. The screw-down handle 3 has a threaded portion 4 and a foot 10. The screw-down handle 3 is turned in the clock-wise direction to turn the threaded portion 4 to apply pressure by the foot 10 of the screw-down handle 3. When the screw-down handle 3 is turned counter-clockwise, the threaded portion 4 unscrews and the foot 10 of the screw-down handle 3 away from the flanged plate 9.

The screw-down handle 3 is coupled to the flanged plate 9 by a pivoting arm 6. The pivoting arm 6 has a connecting point to the screw-down handle 3 where the pivoting arm 6 is located at the threaded portion 4 of the screw-down handle 3 at a threaded joint pivoting point 7. The pivoting arm 6 is coupled to the flanged plate 9 by a support post 8. The support post 8 has a hinge 5. The hinge 5 is coupled to the pivoting arm 6 to allow the pivoting arm 6 to be manipulated easily. In the exemplary embodiment, the hinge 5 is coupled to the pivoting arm 6 furthest away from the threaded joint 7.

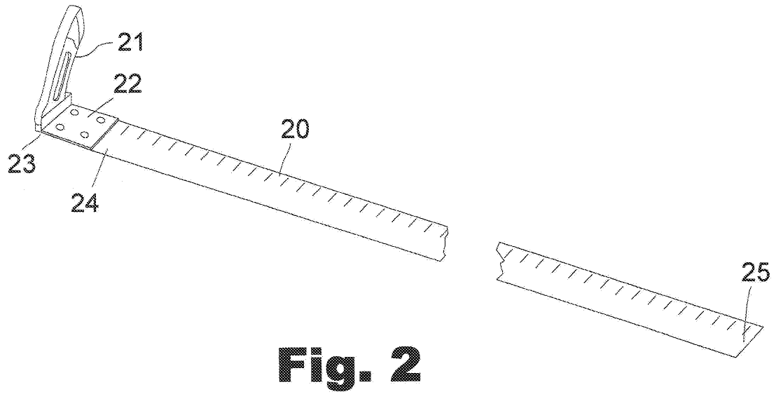

Referring now to FIG. 2, a ruler or elongated flat member 20 is presented. The elongated flat ruler 20 has a first end 24 and a second end 25. A ruler handle 21 is coupled to the elongated flat ruler 20 at the first end 24 of the elongated flat ruler 20. The coupling of the ruler handle 21 to the first end 24 of the elongated flat ruler 20 is accomplished utilizing an attachment plate 22, where the ruler handle 21 is coupled to one side of the attachment plate 22 and the bottom portion of the attachment plate 22 is coupled to the first end 24 of the elongated flat ruler 20. Thus, the elongated flat ruler 20 has a ruler handle 21 to ease the use and provide a more stable edge for cutting drywall.

The ruler handle 21 also has a knife blade 23. This knife blade 23 is used to score drywall as the elongated flat ruler 20 is moved by the ruler handle 21 along drywall at a predetermined length. This coupling of the knife blade 23 and the ruler handle 21 prevents the knife blade 23 from moving in a direction away from the elongated flat ruler 20, thus the drywall scoring is straight and clean.

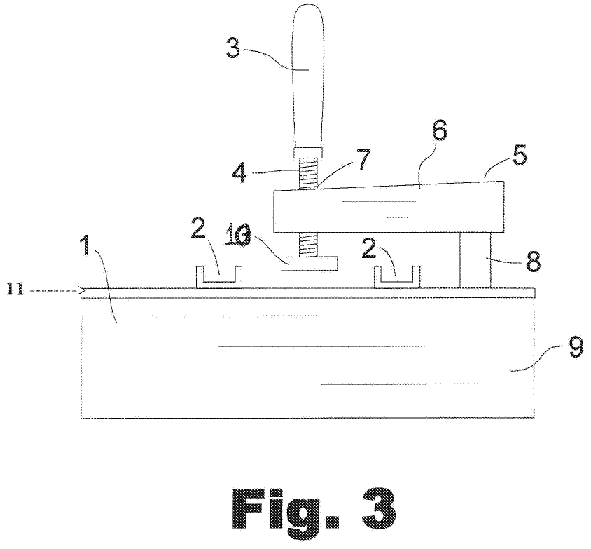

Moving now to FIG. 3, a side view of the support bracket 1 is described.

The support bracket has a flanged plate 9. The flanged plate 9 has a plurality of guide tracks 2 on an upper surface 11. In the exemplary embodiment, the guide tracks 2 are parallel.

Further, the flanged plate 9 also has a screw-down clamp handle 3 located between the guide tracks 2. The screw-down handle 3 has a threaded portion 4 and a foot 10. The foot 10 of the screw-down handle 3 is presented not against the flanged plate 9. The screw-down handle 3 is turned in the clock-wise direction to turn the threaded portion 4 to apply pressure by the foot 10 of the screw-down handle 3. When the screw-down handle 3 is turned counter-clockwise, the threaded portion 4 unscrews and the foot 10 of the screw-down handle 3 away from the flanged plate 9.

The screw-down handle 3 is coupled to the flanged plate 9 by a pivoting arm 6. The pivoting arm 6 has a connecting point to the screw-down handle 3 where the pivoting arm 6 is located at the threaded portion 4 of the screw-down handle 3 at a threaded joint pivoting point 7. The pivoting arm 6 is coupled to the flanged plate 9 by a support post 8. The support post 8 has a hinge 5. The hinge 5 is coupled to the pivoting arm 6 to allow the pivoting arm 6 to be manipulated easily. In the exemplary embodiment, the hinge 5 is coupled to the pivoting arm 6 furthest away from the threaded joint 7.

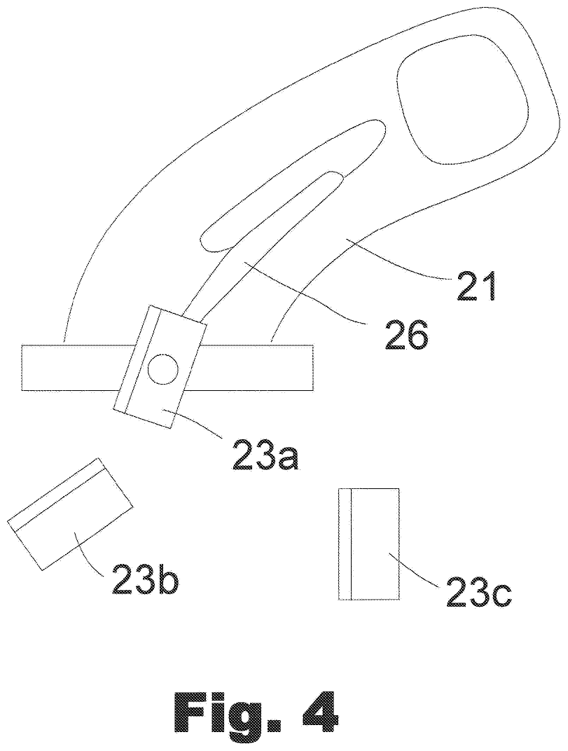

FIG. 4 is now described. FIG. 4 is a detailed view of the exemplary ruler handle 21. The ruler handle 21 has a retractor 26 couple to one side of the ruler handle 21. Knife blade 23a, 23b, 23c are attachable to the retractor 26 coupled to the ruler handle 21. The blade 23a, 23b, 23c protrude from the ruler handle 21 allowing for the ruler handle 21 to be scoring drywall.

The knife blades 23a, 23b, 23c are shown attached to the ruler handle 21 at a 15-degree angle 23a, at a 45-50-degree angle 23b and at a 0-degree angle 23c. Although the previous mentioned angles for the knife blade 23a, 23b, 23c are the most commonly used angles when cutting drywall, one could have any angle for the knife blade 23a, 23b, 23c.

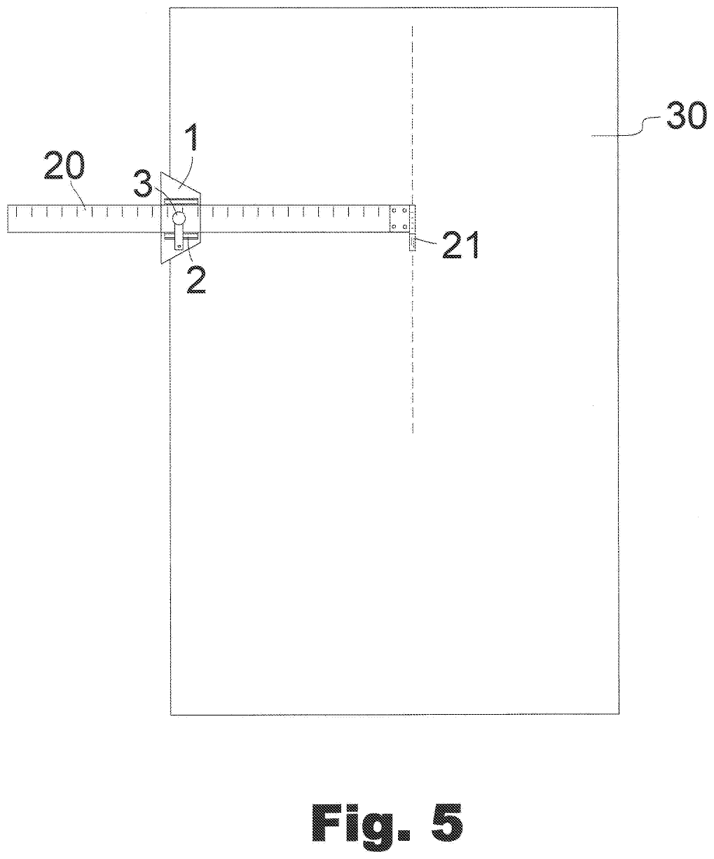

Now presenting FIG. 5. FIG. 5 presents an exemplary use of the drywall cutting tool. A measurement has been performed to determine the appropriate size of the drywall sheet 30 necessary in construction.

The support bracket 1 is placed onto the drywall sheet 30 on one of its long edges. A elongated flat ruler 20 is placed between the guides 2 of the support bracket 1. The first end 24 of the rule 20 is located on the drywall sheet 30. The ruler handle 21 is located at the appropriate length as determined in the previously mentioned measurement. The elongated flat ruler 20 is tightened at the guides 2 to prevent the elongated flat ruler 20 from sliding. The ruler handle 21 is then moved in one direction to score the drywall sheet 30 for later breaking the drywall sheet. Thus, the drywall sheet 30 will be the previously determined dimension.

The drywall cutting tool would, as an exemplary embodiment, be used as follows: The elongated flat ruler 20 has a knife blade 23 with a ruler handle 21 attached to the first end 24 of the elongated flat ruler 20. A support bracket 1 has a flat top portion with a flange 9 along one side. The support bracket 1 has a guides 2 on the top of the support bracket 1 that can receive the second end 25 of the elongated flat ruler 20 and the elongated flat ruler 20 is allowed to slide along the top of the support bracket 1 to any desired measurement length.

A screw-down handle 3 is attached to the top portion of the support bracket and pinches to secure the elongated flat ruler 20 in the guides 2 to keep the elongated flat ruler 20 at the desired measurement length.

The tool allows the support bracket to be placed on an edge of a drywall sheet 30 and the knife blade 23 is positioned at the desired measurement length so that the drywall sheet 30 may be cut at the desired measurement length by moving the support bracket 1 and the knife blade 23 together along the drywall sheet 30.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A drywall cutting tool comprising:
an elongated flat ruler (20) having first (24) and second ends (25);
a knife blade (23) with a handle (21) attached to the first end (24) of the ruler (20);
a support bracket (1) having a flat top portion with a flange (9) along one side;
a pair of guides (2) on the top portion of the support bracket configured to receive the second end (25) of the ruler and allow the ruler to slide along the top portion of the support bracket (1) to any desired measurement length;
a screw-down handle (3, 4, 10) attached to the top portion of the support bracket configured to pinch and secure the ruler (20) in the guides at the desired measurement length;
whereby, the tool allows the support bracket to be placed on an edge of a drywall sheet (30) and the knife blade (23, 23a, 23b, 23c) to be positioned at the desired measurement length so that the drywall sheet may be cut at the desired measurement length by moving the support bracket and the knife blade (23) together along the drywall sheet.

2. The drywall cutting tool of claim 1 wherein the screw-down handle (3) is mounted to the support bracket (1) with a pivoting arm (6).

3. The drywall cutting tool of claim 2 wherein the screw-down handle (3) is threadedly attached (7, 4) to the pivoting arm (6).

4. The drywall cutting tool of claim 2 wherein the pivoting arm is hinged (5) to the support bracket (1).

5. The drywall cutting tool of claim 1 wherein the knife blade (23) is retractable (26).

6. The drywall cutting tool of claim 1 wherein the knife blade has an adjustable angle of attack between 0 degrees (23c) and 50 degrees (23b).

7. The drywall cutting tool of claim 6 wherein the knife blade has an angle of attack of 15 degrees (23a).

8. The drywall cutting tool of claim 1 wherein the screw-down handle (3) has an upper wooden portion.

9. A tool for cutting drywall sheets (30) comprising:
a rigid flanged plate (1, 9) having an attached pair of parallel guide tracks (2) on an upper surface, the flanged plate also having a screw-down clamp handle (3, 4, 10) located between the parallel guide tracks;
an elongated flat member (20) configured to slide between the parallel guide tracks (2) and be locked down by the screw-down clamp handle (3), the elongated flat member including a retractable knife blade (23) attached (22) to a distal end;
wherein, when the flanged plate is placed on an edge of a drywall sheet (30), the elongated flat member (20) may be slid in the parallel guide tracks to establish a desired distance onto the sheet (30) for cutting and then locked down with the screw-down clamp handle (3) to maintain the desired distance during cutting.

10. The tool of claim 9 wherein the distal end of the elongated flat member (20) also includes an attached protruding handle (21).

11. The tool of claim 10 wherein the knife blade (23) retracts (26) into the protruding handle (21) when not in use.

12. The tool of claim 9 wherein the elongated flat member (20) is a ruler.

13. The tool of claim 9 wherein the screw-down clamp handle (3) is mounted to the flanged plate with a pivoting arm (6).

14. The tool of claim 13 wherein the screw-down clamp handle (3) is threadedly attached (4, 7) to the pivoting arm (6).

15. The tool of claim 13 wherein the pivoting arm (6) is hinged (5, 8)) to the flanged plate (1).

16. The tool of claim 9 wherein the flanged plate (1) has a right-angle flange (9) along one edge.

17. A drywall cutting tool used to make precision cuts in drywall sheets (30) that includes a flat ruler (20) with an attached knife blade (23) and knife handle (21) on a first end (24), the flat ruler cooperating with a flanged end support (1) to allow the flanged end support to slide along an edge of a drywall sheet during cutting, the flanged end support constructed to allow the flat ruler to be clamped (10) to the flat end support at a desired cutting distance placing the knife blade (23) at the desired cutting distance from the said edge of the drywall sheet (30).

18. The drywall cutting tool of claim 17 wherein the flat ruler (20) is clamped to the flat end support (1) with a threadably mounted (4, 7) clamp handle (3).

19. The drywall cutting tool of claim 18 wherein the clamp handle (3) is mounted to the flanged plate with a pivoting arm (6).

20. The drywall cutting tool of claim 17 wherein the flanged end support (1) is a flat plate with a right-angle flange (9) alone one side
